(19) United States
(12) Patent Application Publication
(10) Pub. No.: US 2010/0100968 A1
(43) Pub. Date: Apr. 22, 2010

(54) IMAGE PROCESSING APPARATUS

(76) Inventor: Koji URASAWA, Tokyo (JP)

Correspondence Address: Kazunao Kubotera;KUBOTERA & ASSOCIATES, LLC, Suite 202, 200 Daingerfield Road, Alexandria, VA, 22314, US

(21) Appl. No.: 12/604,470

(22) Filed: Oct. 23, 2009

(30) Foreign Application Priority Data
Oct. 20, 2008 (JP) 2008-269622

(51) Int. Cl. H04L 9/32

(52) U.S. Cl. 726/28

(57) ABSTRACT

An image processing apparatus includes an input receiving unit for receiving an input of identification information to identify a user; a storage unit for storing the identification information and usage authority of the user with respect to a function of the image processing apparatus; a control information storage unit for storing unregistered user control information for allowing an unregistered user with usage authority not registered in the storage unit to use a minimum function of the image processing apparatus; a determining unit for searching the storage unit according to the identification information and determining whether the identification information is registered; and a control unit for controlling to allow the unregistered user to use the minimum function according to the unregistered user control information when the determining unit determines that the identification information is not registered in the storage unit.

### BACKGROUND OF THE INVENTION AND RELATED ART STATEMENT

The present invention relates to an image processing apparatus. More specifically, the present invention relates to an image processing apparatus for controlling an access of a user to a function of the image processing apparatus according to access authority of the user with respect to the image processing apparatus.

Patent Reference has disclosed a conventional output system having a usage authority authentication function as a system having an image processing apparatus. In the conventional output system, a user terminal, a printer, and an authentication server are connected through a network. In the conventional output system, the user terminal is used for a user to log in using a user ID thereof through a user authorization process. Afterward, the user operates to send document data and the user ID together with a print request to the printer for performing a printing operation. Patent Reference: Japanese Patent Publication No. 2005-135373

When the printer receives the document data and the user ID together with the print request, the printer retrieves text data and image data (material data) from the document data. When the printer retrieves the material data, the printer sends the user ID together with an authentication request to the authentication server for authenticating access authority of the user with respect to the printer.

The authentication server has a storage unit for storing access control information correlating user IDs of a plurality of users with usage permission information for identifying a function of the printer that each user can use. When the authentication server receives the user ID, the authentication server searches the storage unit according to the user ID to determine whether the access control information corresponding to the user ID is stored in the storage unit.

When the authentication server determines that the access control information corresponding to the user ID is stored in the storage unit, the authentication server sends usage permission information contained in the access control information to the printer. When the authentication server determines that the access control information corresponding to the user ID is not stored in the storage unit, the authentication server sends output control information to the printer.

When the printer receives the usage permission information, the printer prints a text and an image (a material) within a usage permission range according to the usage permission information thus received and the material data retrieved from the document data. When the printer receives the output control information, the printer performs an output control process such as a mosaic process on the material data thus retrieved according to the output control information thus received, so that the printer performs the printing operation according to the material data with, for example, the mosaic process applied thereto.

In the conventional output system, when the user ID is not stored in the storage unit of the authentication server, the user cannot use the printer. In other words, in the conventional output system, if an administrator forgets to register a user ID of a user in the storage unit of the authentication server, when the user logs in the user terminal, the user cannot use the printer, even through the user is already registered as an authorized user, thereby causing inconvenience.

In view of the problems described above, an object of the present invention is to provide an image processing apparatus capable of solving the problems. In image processing apparatus, when access authority information of a user indicating access authority of the user with respect to a function of the image processing apparatus is not registered, the user is still allowed to access to a minimum function of the image processing apparatus, thereby improving convenience of the user.

Further objects and advantages of the invention will be apparent from the following description of the invention.

### SUMMARY OF THE INVENTION

In order to attain the objects described above, according to the present invention, an image processing apparatus includes an input receiving unit for receiving an input of identification information to identify a user; a storage unit for storing the identification information and corresponding usage authority of the user with respect to a function of the image processing apparatus; a control information storage unit for storing unregistered user control information for allowing a user with usage authority not registered in the storage unit to use a minimum function of the image processing apparatus; a determining unit for searching the storage unit according to the identification information thus input and determining whether the identification information is registered; and a control unit for controlling to allow to use the minimum function of the image processing apparatus according to the unregistered user control information stored in the control information storage unit when the determining unit determines that the identification information is not registered.

In the present invention, the image processing apparatus includes the control information storage unit for storing the unregistered user control information for allowing the user with the usage authority not registered in the storage unit to use the minimum function of the image processing apparatus. Accordingly, even the user with the usage authority not registered can use the minimum function of the image processing apparatus.

### BRIEF DESCRIPTION OF THE DRAWINGS

FIG. 1 is a block diagram showing a configuration of an image processing system having an image processing apparatus according to a first embodiment of the present invention;

FIG. 2 is a schematic view showing an example of a configuration of an access authority information database (DB) according to the first embodiment of the present invention;

FIG. 3 is a schematic view showing an example of a configuration of an access control information database (DB) according to the first embodiment of the present invention;

FIG. 4 is a schematic view showing an example of a display of login screen information according to the first embodiment of the present invention;

FIG. 5 is a schematic view showing an example of a configuration of a user authentication information database (DB) according to the first embodiment of the present invention;

FIG. 6 is a schematic view showing an example of a display of failed login screen information according to the first embodiment of the present invention;

FIG. 7 is a schematic view showing an example No. 1 of a display of main menu screen information according to the first embodiment of the present invention;

FIG. 8 is a schematic view showing an example No. 2 of the display of the main menu screen information according to the first embodiment of the present invention;

FIG. 9 is a schematic view showing an example of a display of printout password setting screen information at a user terminal according to the first embodiment of the present invention;

FIG. 10 is a schematic view showing an example of a display of printout password input screen information according to the first embodiment of the present invention;

FIG. 11 is a flow chart showing an operation of the image processing apparatus according to the first embodiment of the present invention;

FIG. 12 is a block diagram showing a configuration of an image processing system having an image processing apparatus according to a second embodiment of the present invention;

FIG. 13 is a schematic view showing an example of a configuration of an access authority information database (DB) according to the second embodiment of the present invention;

FIG. 14 is a schematic view showing an example of a display of login screen information according to the second embodiment of the present invention;

FIG. 15 is a schematic view showing an example of a configuration of a user biometric information database (DB) according to the second embodiment of the present invention; and

FIG. 16 is a flow chart showing an operation of the image processing apparatus according to the second embodiment of the present invention.

### DETAILED DESCRIPTION OF THE PREFERRED EMBODIMENTS

Hereunder, embodiments of the present invention will be explained with reference to the accompanying drawings.

### First Embodiment

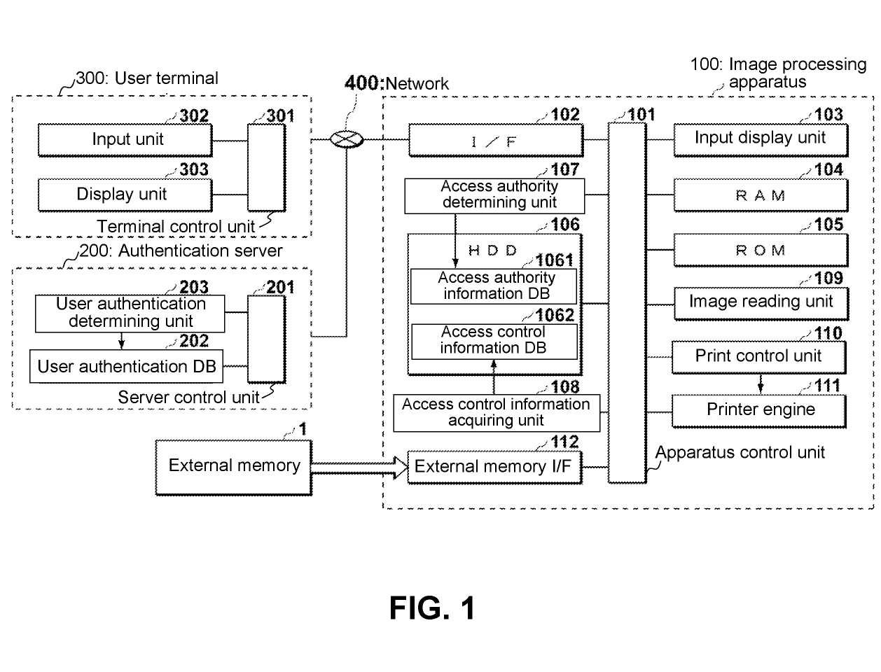

A first embodiment of the present invention will be explained. FIG. 1 is a block diagram showing a configuration of an image processing system having an image processing apparatus 100 according to the first embodiment of the present invention.

As shown in FIG. 1, the image processing apparatus 100 is connected to an authentication server 200 and a user terminal 300 through a network 400. Note that the image processing apparatus 100 includes a multi function product (MFP) installed in, for example, an office, and has a printing function, a copying function, and a scanning function.

In the embodiment, the authentication server 200 performs authentication of a user operating the image processing apparatus 100, and is installed in an administration center. The user terminal 300 includes a personal computer (PC) and the likes for a user in an office, and is installed in the office where the image processing apparatus 100 is installed.

For the sake of presentation, only one of the authentication server 200 or the user terminal 300 is shown in FIG. 1. In an actual case, the network 400 is connected to a plurality of image processing apparatus and user terminals having a function similar to those of the authentication server 200 and the user terminal 300.

A control system of the image processing apparatus 100 will be explained next with reference to FIG. 1.

As shown in FIG. 1, the image processing apparatus 100 includes an apparatus control unit 101; an interface I/F 102 for communicating with the authentication server 200 and the user terminal 300 connected thereto through the network 400; an input display unit 103 formed of various buttons and a touch panel display; an RAM (Random Access Memory) 104 for temporarily storing various information; an ROM (Read Only Memory) 105 for storing various programs executed with the apparatus control unit 101; an HDD (Hard Disk Drive) 106; an access authority determining unit 107; an access control information acquiring unit 108; an image reading unit 109 having a scanning function for optically reading an original placed on an original stage (not shown) to generate image data; a print control unit 110; a printer engine 111; and an external memory interface 112 for connecting an external memory 1 to a main body of the image processing apparatus 100.

In the embodiment, the HDD 106 is a storage device installed in the main body of the image processing apparatus 100. As shown in FIG. 1, the HDD 106 includes an access authority information database (DB) 1061 and an access control information database (DB) 1062.

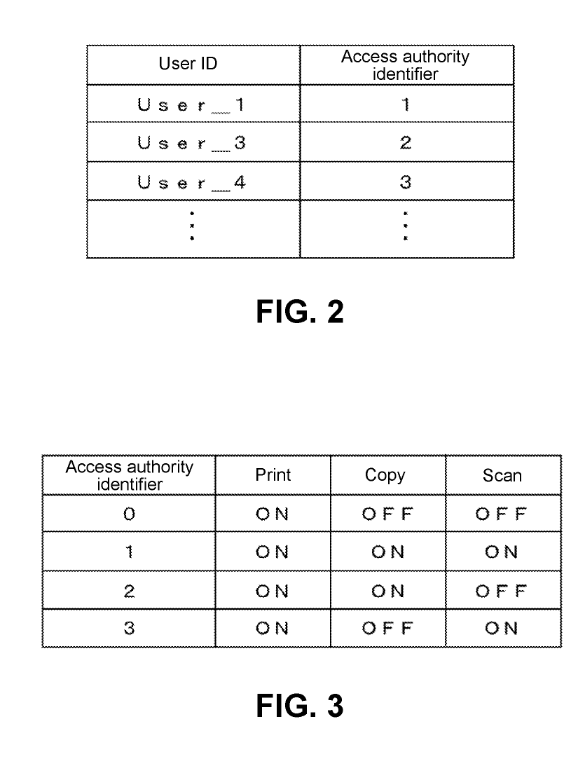

FIG. 2 is a schematic view showing an example of a configuration of the access authority information database (DB) 1061 according to the first embodiment of the present invention. As shown in FIG. 2, the access authority information database (DB) 1061 stores access authority information containing user IDs of a plurality of users and access authority identifiers (described later) indicating a level of access authority of each user.

FIG. 3 is a schematic view showing an example of a configuration of the access control information database (DB) 1062 according to the first embodiment of the present invention. As shown in FIG. 3, the access control information database (DB) 1062 stores access control information correlating each of the access authority identifiers to information of each function of the image processing apparatus 100 to which a user having each of the access authority identifiers can access.

In FIG. 3, the access authority identifier “0” is assigned to a user not registered in the access control information database (DB) 1062. As shown in FIG. 3, the user not registered in the access control information database (DB) 1062 (with the access authority identifier “0”) can access only to the printing function (ON), and cannot access to the copying function and the scanning function (OFF).

In the embodiment, it is arranged such that the user not registered in the access control information database (DB) 1062 (with the access authority identifier “0”) can access only to the printing function according to the print data received from the user terminal 300, so that the user not registered in the access control information database (DB) 1062 cannot make a copy of a confidential document or read an original. Alternatively, it may be arranged such that the user not registered in the access control information database (DB) 1062 can access only to the scanning function, so that the user not registered in the access control information database (DB) 1062 cannot use consumable supply such as a print paper and toner. In this case, the scanning function becomes the minimum function.

In FIG. 3, the access authority identifier “1” is assigned to an administrative user having a highest access authority. As shown in FIG. 3, the administrative user (with the access authority identifier “1”) can access to all of the functions (ON) of the image processing apparatus 100 (the printing function, the copying function, and the scanning function).

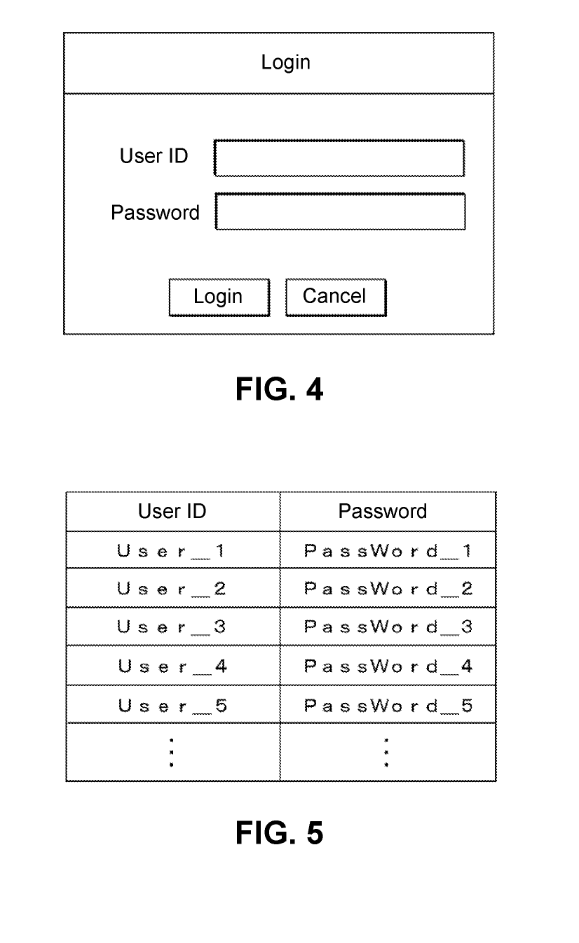

FIG. 4 is a schematic view showing an example of a display of login screen information of the image processing apparatus 100 according to the first embodiment of the present invention.

When the user operates a power switch (not shown) to turn on the image processing apparatus 100, the apparatus control unit 101 starts a corresponding program stored in the ROM 105. Accordingly, the login screen information (initial screen information) shown in FIG. 4 is displayed on the touch panel display of the input display unit 103, so that the user can input the user ID and a password. As shown in FIG. 4, the login screen information includes text boxes for inputting the user ID and the password and a login button for instructing login.

In the embodiment, when the user refers to the login screen information displayed on the touch panel display, operates the input buttons on the input display unit 103 to input the user ID and the password, and pushes the login button, the apparatus control unit 101 stores the user ID and the password in the RAM 104. After the apparatus control unit 101 stores the user ID and the password in the RAM 104, the apparatus control unit 101 sends the user ID and the password to the authentication server 200 through the interface I/F 102.

As shown in FIG. 1, the authentication server 200 includes a server control unit 201 for controlling an entire operation of the authentication server 200; a user authentication database (DB) 202; and a user authentication determining unit 203. Further, the authentication server 200 includes an interface (I/F, not shown) for communicating with the image processing apparatus 100 and the user terminal 300 connected thereto through the network 400.

FIG. 5 is a schematic view showing an example of a configuration of the user authentication information database (DB) 202 according to the first embodiment of the present invention.

As shown in FIG. 5, the user authentication database (DB) 202 stores user authentication information correlating the user IDs of a plurality of users with the passwords of the users. A server administrator registers and administers the user authentication information registered in the user authentication database (DB) 202.

In the embodiment, when the server control unit 201 receives the user ID and the password from the image processing apparatus 100 or the user terminal 300 through the interface (I/F, not shown), the server control unit 201 stores the user ID and the password in an RAM (not shown) disposed in the authentication server 200. After the server control unit 201 stores the user ID and the password, the server control unit 201 instructs the user authentication determining unit 203 to perform user authentication determination.

In the embodiment, when the user authentication determining unit 203 receives the instruction of the user authentication determination, the user authentication determining unit 203 searches the user authentication database (DB) 202 according to the user ID and the password thus received. When the user authentication information corresponding to the user ID and the password is stored in the user authentication database (DB) 202, the user authentication determining unit 203 determines that the user matches to the user authentication information. When the user authentication determining unit 203 determines that the user matches to the user authentication information, the server control unit 201 generates a user match signal, and sends the user match signal to the image processing apparatus 100 or the user terminal 300 as an originator of the user ID and the password through the interface (I/F, not shown).

When the user authentication information corresponding to the user ID and the password is not stored in the user authentication database (DB) 202, the user authentication determining unit 203 determines that the user does not match to the user authentication information. When the user authentication determining unit 203 determines that the user does not match to the user authentication information, the server control unit 201 generates a user mismatch signal, and sends the user mismatch signal to the image processing apparatus 100 or the user terminal 300 through the interface (I/F, not shown).

In the embodiment, when the apparatus control unit 101 of the image processing apparatus 100 receives the user match signal through the interface I/F 102, the apparatus control unit 101 instructs the access authority determining unit 107 to determine access authority. On the other hand, when the apparatus control unit 101 of the image processing apparatus 100 receives the user mismatch signal through the interface I/F 102, the apparatus control unit 101 starts a corresponding program stored in the ROM 105. Accordingly, failed login screen information is displayed on the touch panel display to notify that the login is failed using a text and a marking.

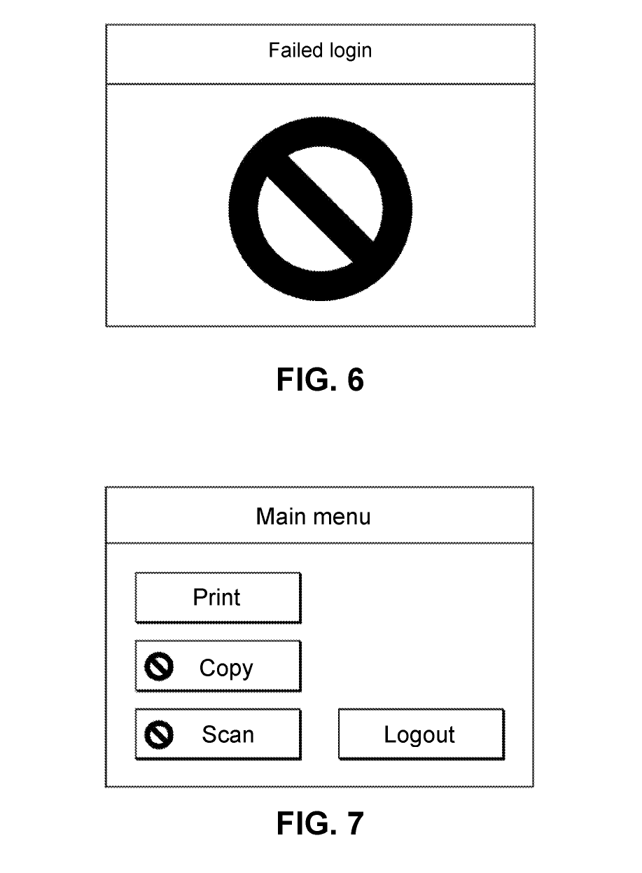

FIG. 6 is a schematic view showing an example of a display of the failed login screen information according to the first embodiment of the present invention. In the embodiment, the apparatus control unit 101 displays the failed login screen information on the touch panel display for a specific period of time set in advance. Afterward, the apparatus control unit 101 displays the login screen information as the initial screen information shown in FIG. 4 on the touch panel display.

In the embodiment, the access authority determining unit 107 determines whether the access authority information corresponding to the user ID of the user thus authenticated is registered. When the access authority determining unit 107 determines that the access authority information is registered, the access authority determining unit 107 determines the access authority of the user according to the access authority identifier contained in the access authority information.

More specifically, when the access authority determining unit 107 receives the instruction to determine the access authority, the access authority determining unit 107 searches the access authority information database (DB) 1061 according to the user ID stored in the RAM 104. When the access authority information corresponding to the user ID is stored in the access authority information database (DB) 1061, the access authority determining unit 107 determines that the access authority identifier (1, 2, or 3) contained in the access authority information is the access authority of the user.

On the other hand, when the access authority information corresponding to the user ID is not stored in the access authority information database (DB) 1061, the access authority determining unit 107 determines that the access authority information of the user is not registered. Accordingly, the access authority determining unit 107 determines that the access authority identifier “0” indicating the lowest access authority is the access authority of the user.

After the access authority determining unit 107 determines the access authority of the user, the apparatus control unit 101 stores the access authority identifier (1, 2, or 3) in the RAM 104. After the apparatus control unit 101 stores the access authority identifier, the apparatus control unit 101 instructs the access control information acquiring unit 108 to acquire the access control information corresponding to the access authority.

In the embodiment, the access control information acquiring unit 108 acquires the access control information corresponding to the access authority according to the access authority thus determined. More specifically, when the access control information acquiring unit 108 receives the instruction to acquire the access control information, the access control information acquiring unit 108 searches the access control information database (DB) 1062 according to the access authority stored in the RAM 104 (for example, “0”). Accordingly, the access control information acquiring unit 108 acquires the access control information corresponding to the access authority shown in FIG. 3 (for example, Print=ON, Copier=OFF, Scan=OFF).

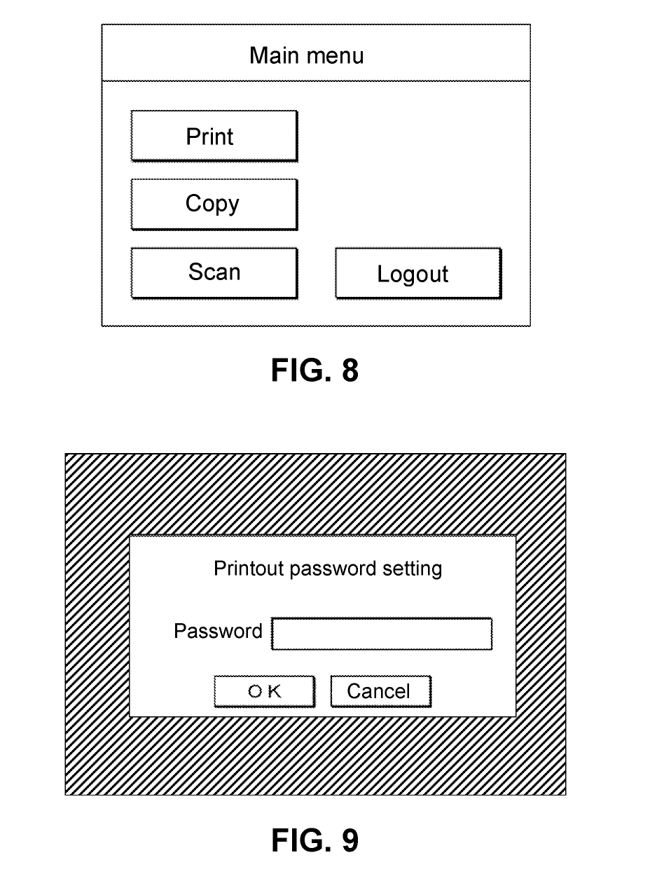

FIG. 7 is a schematic view showing an example No. 1 of a display of main menu screen information of the image processing apparatus 100 according to the first embodiment of the present invention. FIG. 8 is a schematic view showing an example No. 2 of the display of the main menu screen information of the image processing apparatus 100 according to the first embodiment of the present invention.

When the access control information acquiring unit 108 acquires the access control information (for example, Print=ON, Copier=OFF, Scan=OFF), the apparatus control unit 101 starts a corresponding program stored in the ROM 105, so that the main menu screen information shown in FIG. 7 is displayed on the touch panel display.

As shown in FIG. 7, the main menu screen information includes a print menu button indicating that the user can access to the printing process; a copy menu button with a prohibition marking indicating that the user cannot access to the copying process; and a scan menu button with a prohibition marking indicating that the user cannot access to the scanning process.

In the main menu screen information, the user cannot push a menu button with the prohibition marking. Accordingly, when the access authority of the user is zero, the user can access only to the printing process as the minimum function of the image processing apparatus 100. When the user pushes a logout button in the main menu screen information, the apparatus control unit 101 displays the login screen information as the initial screen information shown in FIG. 4.

When the access control information acquiring unit 108 acquires the access control information (for example, Print=ON, Copier=ON, Scan=ON), the apparatus control unit 101 starts a corresponding program stored in the ROM 105, so that the main menu screen information shown in FIG. 8 is displayed on the touch panel display. As shown in FIG. 8, the main menu screen information includes the print menu button indicating that the user can access to the printing process; the copy menu button indicating that the user can access to the copying process; and the scan menu button indicating that the user can access to the scanning process. Accordingly, when the access authority of the user is one, the user can access to all of the functions of the image processing apparatus 100.

A control system of the user terminal 300 will be explained. As shown in FIG. 1, the user terminal 300 includes a terminal control unit 301 for controlling an entire process of the user terminal 300; an input unit 302 having various buttons; and a display unit 303 having a display. Further, the user terminal 300 includes an interface (I/F, not shown) for communicating with the image processing apparatus 100 and the authentication server 200 through the network 400.

When the user operates a power switch (not shown) disposed in the user terminal 300 to turn on the user terminal 300, the terminal control unit 301 starts a corresponding program stored in an ROM (not shown) disposed in the user terminal 300. Accordingly, login screen information is displayed on the display of the display unit 303, so that the user can input the user ID and the password.

In the embodiment, when the user refers to the login screen information displayed on the display, and operates the input buttons on the input unit 302 to input the user ID and the password, the terminal control unit 301 stores the user ID and the password in an RAM (not shown) disposed in the user terminal 300. After the terminal control unit 301 stores the user ID and the password in the RAM, the terminal control unit 301 sends the user ID and the password to the authentication server 200 through the interface (I/F, not shown).

In the embodiment, when the terminal control unit 301 receives the user match signal as a response to the transmission of the user ID and the password from the authentication server 200 through the interface (I/F, not shown), the terminal control unit 301 starts a corresponding program stored in the ROM (not shown) disposed in the user terminal 300, so that the terminal control unit 301 performs the login process with respect to the user terminal 300.

On the other hand, when the terminal control unit 301 receives the user mismatch signal from the authentication server 200 through the interface (I/F, not shown), the terminal control unit 301 starts a corresponding program stored in the ROM (not shown) disposed in the user terminal 300, so that the terminal control unit 301 notifies that the login process with respect to the user terminal 300 is failed. Further, the terminal control unit 301 displays re-input screen information (not shown) on the display, so that the user is prompted to re-input the user ID and the password.

In the embodiment, when the user operates the user terminal 300 to create document data using application software stored in the ROM, and pushes a print button provided in the application software for instructing a printing operation, the terminal control unit 301 converts the document data to print data with a printable data format using a printer driver (not shown) disposed in the user terminal 300.

FIG. 9 is a schematic view showing an example of a display of printout password setting screen information at the user terminal 300 according to the first embodiment of the present invention.

In the embodiment, when the terminal control unit 301 generates the print data, the terminal control unit 301 starts a corresponding program stored in the ROM. Accordingly, the terminal control unit 301 displays the printout password setting screen information shown in FIG. 9 on the display of the display unit 303, so that the user sets the password for printout.

As shown in FIG. 9, the printout password setting screen information includes a text box for inputting the password for printout; an OK button for requesting the printing operation using the password thus input; and a cancel button for cancelling the request for the printing operation. Note that the password for printout may be a text string formed of alphabets and numbers set by the user.

In the embodiment, when the user refers to the printout password setting screen information displayed on the display, operates the input button to input the password for printout, and pushes the OK button, the terminal control unit 301 adds the password for printout to the print data stored in the RAM (not shown), and sends the print data to the image processing apparatus 100 through the interface (I/F, not shown).

After the terminal control unit 301 sends the print data to the image processing apparatus 100, the terminal control unit 301 starts a corresponding program stored in the ROM (not shown), so that the terminal control unit 301 displays notice screen information on the display for a specific period of time indicating that the user operates the image processing apparatus 100 using the password for printout. Afterward, the user moves to a location where the image processing apparatus 100 is installed, so that the user instructs the image processing apparatus 100 to perform the printing process according to the print data thus sent.

On the other hand, when the user refers to the printout password setting screen information, and pushes the cancel button, the terminal control unit 301 starts a corresponding program stored in the ROM (not shown), so that the terminal control unit 301 displays the notice screen information on the display for a specific period of time indicating that the user cancels the printing process according to the print request.

In the embodiment, when the apparatus control unit 101 of the image processing apparatus 100 receives the print data from the user terminal 300 through the interface I/F 102, the apparatus control unit 101 stores the print data in the RAM 104. After the apparatus control unit 101 stores the print data, the apparatus control unit 101 proceeds to a job waiting state.

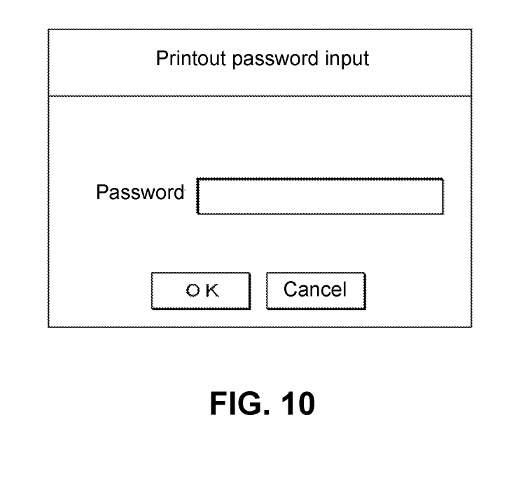

FIG. 10 is a schematic view showing an example of a display of printout password input screen information according to the first embodiment of the present invention.

In the embodiment, when the user refers to the main menu screen information displayed on the touch panel display of the image processing apparatus 100, and pushes the print menu button to perform the printing operation, the apparatus control unit 101 starts a corresponding program stored in the ROM 105. Accordingly, the apparatus control unit 101 displays the printout password input screen information on the touch panel display, so that the user inputs the password for printout.

As shown in FIG. 10, the printout password input screen information includes a text box for inputting the password for printout; an OK button for requesting the printing operation; and a cancel button for canceling the request for the printing operation.

In the embodiment, when the user refers to the printout password input screen information, operates the input button to input the password for printout, and pushes the OK button, the apparatus control unit 101 searches the RAM 104 according to the password for printout. When the print data with the password are stored in the RAM 104, the apparatus control unit 101 instructs a rasterize conversion unit (not shown) to perform a rasterize conversion.

On the other hand, when the user refers to the printout password input screen information, and pushes the cancel button, the apparatus control unit 101 starts a corresponding program stored in the ROM (not shown), so that the apparatus control unit 101 deletes the printout password input screen information and displays the main menu screen information on the display one more time.

In the embodiment, when the rasterize conversion unit (not shown) of the image processing apparatus 100 receives the instruction of the rasterize conversion, the rasterize conversion unit (not shown) converts the print data stored in the RAM 104 to the image data. After the rasterize conversion unit (not shown) converts the print data to the image data, the apparatus control unit 101 instructs the print control unit 110 to perform the printing operation and sends the image data.

In the embodiment, the print control unit 110 controls the printing process of the image data, and controls each component constituting the printer engine 111. More specifically, when the print control unit 110 receives the instruction of the printing operation and the image data, the print control unit 110 sends a print instruction signal for instructing the printing operation and the image data to the printer engine 111.

In the embodiment, the printer engine 111 performs the printing process according to the image data. When the printer engine 111 receives the print instruction signal and the image data, the printer engine 111 performs the printing process according to the image data. When the printer engine 111 completes the printing process according to the image data, the print control unit 110 sends an image data print completion signal indicating the completion of the printing process of the image data to the apparatus control unit 101.

When the apparatus control unit 101 receives the image data print completion signal, the apparatus control unit 101 starts a corresponding program stored in the ROM 105. Accordingly, the apparatus control unit 101 displays print completion notice screen notifying that the printing process is complete on the touch panel display. After the apparatus control unit 101 displays the print completion notice screen on the touch panel display for a specific period of time, the apparatus control unit 101 displays the login screen information as the initial screen information on the display.

When the user makes a copy of an original, the user places the original on the original stage (not shown) of the image processing apparatus 100. Afterward, when the user refers to the main menu screen information displayed on the touch panel display and pushes the copy menu button, the apparatus control unit 101 instructs the image reading unit 109 to read an image on the original.

In the embodiment, the image reading unit 109 optically reads the original placed on the original stage using the scanning function, thereby generating the image data. When the image reading unit 109 generates the image data, the apparatus control unit 101 stores the image data in the RAM 104. After the apparatus control unit 101 stores the image data generated upon pushing the copy menu button, the apparatus control unit 101 instructs the printing process and sends the image data.

When the user scans an original, the user places the original on the original stage (not shown) of the image processing apparatus 100. Afterward, when the user refers to the main menu screen information displayed on the touch panel display and pushes the scan menu button, the apparatus control unit 101 instructs the image reading unit 109 to read an image on the original.

In the embodiment, when the image reading unit 109 generates the image data upon pushing the scan menu button, and the apparatus control unit 101 stores the image data in the RAM 104, the apparatus control unit 101 starts a corresponding program stored in the ROM 105. Accordingly, the apparatus control unit 101 displays notice screen information (not shown) indicating that the external memory 1 such as a flash memory is connected to the external memory interface 112 on the touch panel display.

In the embodiment, when the user refers to the notice screen information (not shown) and connects the external memory 1 to the external memory interface 112 of the image processing apparatus 100, the apparatus control unit 101 sends the image data stored in the RAM 104 to the external memory 1.

When the apparatus control unit 101 completes the transmission of the image data, the apparatus control unit 101 starts a corresponding program stored in the ROM 105. Accordingly, the apparatus control unit 101 displays the notice screen information (not shown) indicating that the image data is stored in the external memory 1 and the external memory 1 is ready to be disconnected from the image processing apparatus 100 on the touch panel display.

When the user refers to the notice screen information (not shown) and disconnects the external memory 1 from the external memory interface 112 of the image processing apparatus 100, the apparatus control unit 101 displays the login screen information on the display on more time.

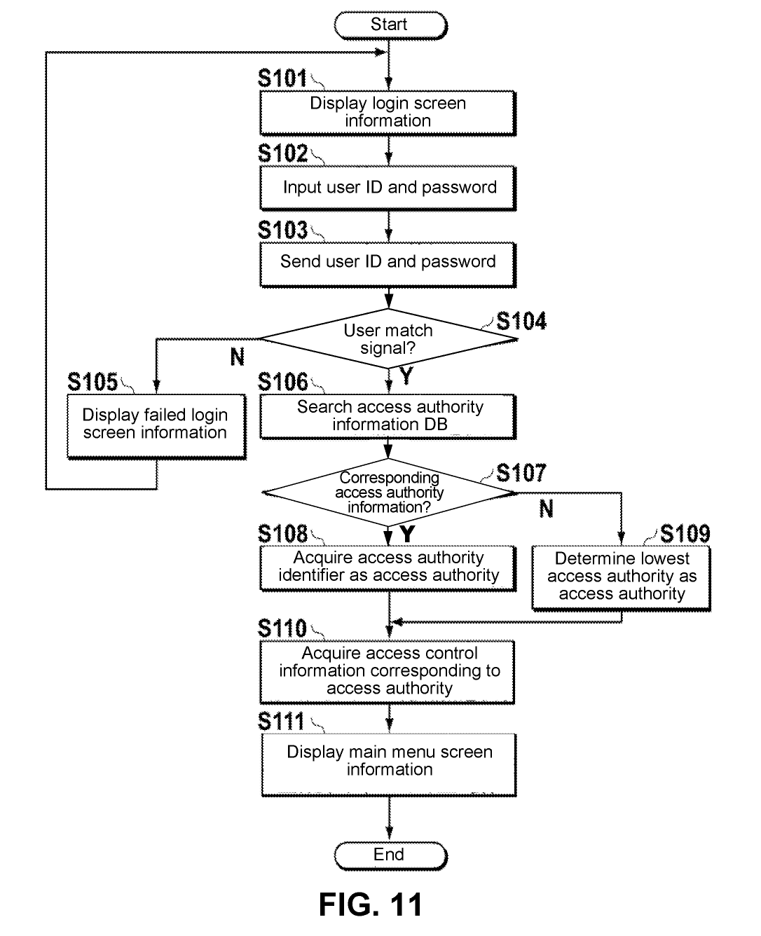

An operation of the image processing apparatus 100 will be explained next with reference to FIG. 11. FIG. 11 is a flow chart showing the operation of the image processing apparatus 100 according to the first embodiment of the present invention.

In the following description, as characteristic features of the image processing apparatus 100, the explanation covers from an operation of displaying the login screen information on the touch panel display to an operation of generating the main menu screen information according to the access authority of the user of the image processing apparatus 100 and displaying the main menu screen information thus generated on the display.

In step S101, when the user operates the power switch (not shown) to turn on the image processing apparatus 100, the apparatus control unit 101 starts the corresponding program stored in the ROM 105. Accordingly, the login screen information (initial screen information) shown in FIG. 4 is displayed on the touch panel display of the input display unit 103, so that the user can input the user ID and the password.

In step S102, the user refers to the login screen information displayed on the touch panel display, operates the input buttons on the input display unit 103 to input the user ID such as User_2 and the password such as PassWord_2, and pushes the login button.

In step S103, after the apparatus control unit 101 stores the user ID and the password in the RAM 104, the apparatus control unit 101 sends the user ID and the password to the authentication server 200 through the interface I/F 102.

In the next step, when the server control unit 201 receives the user ID such as User_2 and the password such as PassWord_2 from the image processing apparatus 100 through the interface (I/F, not shown), the server control unit 201 stores the user ID and the password in the RAM (not shown) disposed in the authentication server 200. After the server control unit 201 stores the user ID and the password, the server control unit 201 instructs the user authentication determining unit 203 to perform the user authentication determination.

In the next step, when the user authentication determining unit 203 receives the instruction of the user authentication determination, the user authentication determining unit 203 searches the user authentication database (DB) 202 (refer to FIG. 5) according to the user ID and the password thus received. When the user authentication information corresponding to the user ID and the password is stored in the user authentication database (DB) 202, the user authentication determining unit 203 determines that the user matches to the user authentication information. When the user authentication determining unit 203 determines that the user matches to the user authentication information, the server control unit 201 generates the user match signal, and sends the user match signal to the image processing apparatus 100 through the interface (I/F, not shown).

On the other hand, when the user authentication information corresponding to the user ID and the password is not stored in the user authentication database (DB) 202, the user authentication determining unit 203 determines that the user does not match to the user authentication information. When the user authentication determining unit 203 determines that the user does not match to the user authentication information, the server control unit 201 generates the user mismatch signal, and sends the user mismatch signal to the image processing apparatus 100 through the interface (I/F, not shown).

In step S104, when the apparatus control unit 101 of the image processing apparatus 100 receives the user match signal through the interface I/F 102, the apparatus control unit 101 instructs the access authority determining unit 107 to determine the access authority.

In step S105, when the apparatus control unit 101 of the image processing apparatus 100 receives the user mismatch signal through the interface I/F 102, the apparatus control unit 101 starts the corresponding program stored in the ROM 105. Accordingly, the failed login screen information shown in FIG. 6 is displayed on the touch panel display to notify that the login is failed using the text and the prohibition marking. Afterward, the apparatus control unit 101 displays the failed login screen information on the touch panel display for a specific period of time set in advance. Then, the apparatus control unit 101 displays the login screen information as the initial screen information shown in FIG. 4 on the touch panel display.

In step S106, when the access authority determining unit 107 receives the instruction to determine the access authority, the access authority determining unit 107 searches the access authority information database (DB) 1061 according to the user ID stored in the RAM 104.

In step S107, the access authority determining unit 107 determines whether the access authority information corresponding to the user ID is stored in the access authority information database (DB) 1061.

In step S108, when the access authority determining unit 107 determines that the access authority information corresponding to the user ID is stored in the access authority information database (DB) 1061, the access authority determining unit 107 determines that the access authority identifier (1, 2, or 3) contained in the access authority information is the access authority of the user.

In step S109, when the access authority determining unit 107 determines that the access authority information corresponding to the user ID such as User_2 is stored in the access authority information database (DB) 1061, the access authority determining unit 107 determines that the access authority information of the user is not registered. Accordingly, the access authority determining unit 107 determines that the access authority identifier “0” indicating the lowest access authority is the access authority of the user.

In the next step, after the access authority determining unit 107 determines the access authority of the user, the apparatus control unit 101 stores the access authority identifier (1, 2, or 3) in the RAM 104. After the apparatus control unit 101 stores the access authority identifier, the apparatus control unit 101 instructs the access control information acquiring unit 108 to acquire the access control information corresponding to the access authority.

In step S110, when the access control information acquiring unit 108 receives the instruction to acquire the access control information, the access control information acquiring unit 108 searches the access control information database (DB) 1062 according to the access authority stored in the RAM 104 (for example, “0”). Accordingly, the access control information acquiring unit 108 acquires the access control information corresponding to the access authority shown in FIG. 3 (for example, Print=ON, Copier=OFF, Scan=OFF).

In step S111, when the access control information acquiring unit 108 acquires the access control information (for example, Print=ON, Copier=OFF, Scan=OFF), the apparatus control unit 101 starts the corresponding program stored in the ROM 105, so that the main menu screen information shown in FIG. 7 is displayed on the touch panel display. As shown in FIG. 7, the main menu screen information includes the print menu button indicating that the user can access to the printing process; the copy menu button with the prohibition marking indicating that the user cannot access to the copying process; and the scan menu button with the prohibition marking indicating that the user cannot access to the scanning process.

Accordingly, when the access authority of the user is zero, the user can access only to the printing process as the minimum function of the image processing apparatus 100.

When the user pushes the logout button in the main menu screen information, the apparatus control unit 101 displays the login screen information as the initial screen information shown in FIG. 4.

When the access control information acquiring unit 108 acquires the access control information (for example, Print=ON, Copier=ON, Scan=ON), the apparatus control unit 101 starts the corresponding program stored in the ROM 105, so that the main menu screen information shown in FIG. 8 is displayed on the touch panel display. As shown in FIG. 8, the main menu screen information includes the print menu button indicating that the user can access to the printing process; the copy menu button indicating that the user can access to the copying process; and the scan menu button indicating that the user can access to the scanning process. Accordingly, when the access authority of the user is one, the user can access to all of the functions of the image processing apparatus 100.

As described above, in the embodiment, the image processing apparatus 100 includes the access control information database (DB) 1062 for storing the access control information with respect to the user with the access authority information not registered in the access authority information database (DB) 1061. Accordingly, as far as the authentication server 200 authenticates the user, the user can access to the printing process as the minimum function of the image processing apparatus 100.

Further, in the image processing system having the image processing apparatus 100, the authentication server 200, that is used the user authentication when the user logs in the user terminal 300, is used for the user authentication when the user logs in the image processing apparatus 100. Accordingly, it is possible to the authentication server 200 in the image processing system without providing another authentication server specifically for the image processing apparatus 100.

### Second Embodiment

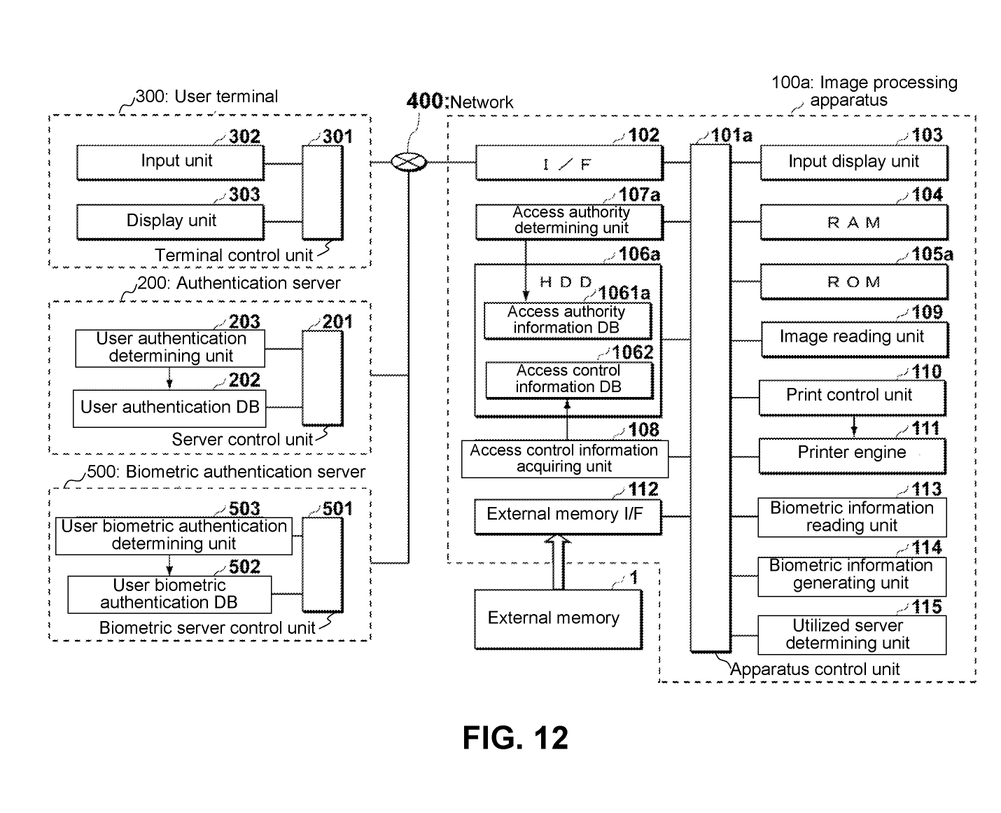

A second embodiment of the present invention will be explained. FIG. 12 is a block diagram showing a configuration of an image processing system having an image processing apparatus 100a according to the second embodiment of the present invention.

In the second embodiment, in addition to the components of the image processing apparatus 100 in the first embodiment, the image processing apparatus 100a includes a biometric information reading unit 113 and a biometric information generating unit 114 (refer to FIG. 12), so that it is possible to authenticate a user using user biometric authentication according to biometric information of the user, in addition to the user authentication according to the user ID and the password.

Further, the image processing apparatus 100a includes a utilized server determining unit 115 (refer to FIG. 12) for determining a server to be requested for the user authentication according to whether the user inputs the user ID and the password, or the biometric information.

As shown in FIG. 12, the image processing system having the image processing apparatus 100a further includes a biometric authentication server 500 for registering biometric information of a plurality of users in advance, so that the biometric authentication server 500 determines whether the user matches according to whether the biometric information sent from the image processing apparatus 100a is registered.

As shown in FIG. 12, the image processing apparatus 100a includes an apparatus control unit 101a for controlling an entire operation of the image processing apparatus 100a; the interface I/F 102 for communicating with the authentication server 200, the user terminal 300, and the biometric authentication server 500 through the network 400; the input display unit 103; the RAM (Random Access Memory) 104; an ROM (Read Only Memory) 105a; an HDD (Hard Disk Drive) 106a; an access authority determining unit 107a; the access control information acquiring unit 108; the image reading unit 109; the print control unit 110; the printer engine 111; the external memory interface 112; the biometric information reading unit 113; the biometric information generating unit 114; and the utilized server determining unit 115.

As shown in FIG. 12, the HDD 106a includes an access authority information database (DB) 1061a and the access control information database (DB) 1062.

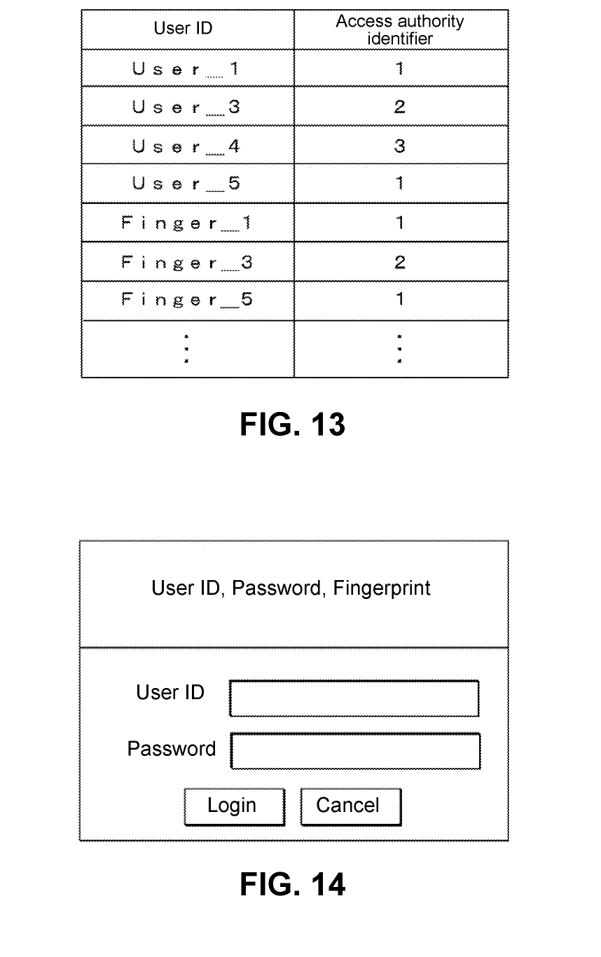

FIG. 13 is a schematic view showing an example of a configuration of the access authority information database (DB) 1061a according to the second embodiment of the present invention. As shown in FIG. 13, the access authority information database (DB) 1061a stores access authority information containing user IDs (User_1, User_2, User_3, User_4, and User_5) of a plurality of users and the access authority identifiers indicating a level of access authority of each user. The access authority information database (DB) 1061a further stores access authority information containing fingerprint information (Finger_1, Finger_3, and Finger_5) of a plurality of users and the access authority identifiers (1, 2, and 3) indicating a level of access authority of each user.

FIG. 14 is a schematic view showing an example of a display of login screen information of the image processing apparatus 100a according to the second embodiment of the present invention.

When the user operates a power switch (not shown) to turn on the image processing apparatus 100a, the apparatus control unit 101a starts a corresponding program stored in the ROM 105a. Accordingly, the login screen information (initial screen information) shown in FIG. 14 is displayed on the touch panel display of the input display unit 103, so that the user can input the user ID, the password, and a fingerprint.

In the embodiment, the biometric information reading unit 113 reads the fingerprint of the user operating the image processing apparatus 100a, and includes a fingertip shooting camera (not shown); a light source (not shown); a glass plate (not shown) for placing a fingertip; a sensor (not shown) for detecting the fingertip contacting with the glass plate; and the likes. Note that the biometric information reading unit 113 has a well-known configuration for shooting a fingertip, and a detailed explanation thereof is omitted.

In the embodiment, when the user refers to the login screen information displayed on the touch panel display, places an index finger on the glass plate of the biometric information reading unit 113, and pushes the glass plate, the sensor detects the index finger, and outputs an index finger detection signal.

In the embodiment, when the biometric information reading unit 113 detects the index finger detection signal, the light source irradiates the index finger of the user placed on the glass plate, so that the fingertip shooting camera takes a picture of the fingertip, thereby generating a fingertip image. When the biometric information reading unit 113 generates the fingertip image, the apparatus control unit 101a stores the fingertip image in the RAM 104. After the apparatus control unit 101a stores the fingertip image in the RAM 104, the apparatus control unit 101a instructs the biometric information generating unit 114 to generate the fingerprint information.

In the embodiment, when the biometric information generating unit 114 receives the instruction to generate the fingerprint information, the biometric information generating unit 114 retrieves a fingerprint pattern from the fingertip image stored in the RAM 104, and codes the fingerprint pattern of the fingertip to generate the fingerprint information. A well-known technology is adapted to retrieve a fingerprint pattern and code the fingerprint pattern to generate the fingerprint information, and a detailed explanation thereof is omitted.

In the embodiment, when the biometric information generating unit 114 generates the fingerprint information, the apparatus control unit 101a stores the fingerprint information in the RAM 104. After the apparatus control unit 101a stores the fingerprint information in the RAM 104, the apparatus control unit 101a instructs the utilized server determining unit 115 to determine a server to be used, and sends the fingerprint information to the utilized server determining unit 115.

In the embodiment, when the user refers to the login screen information, and operates the input button of the input display unit 103 to input the user ID and the password, the apparatus control unit 101a stores the user ID and the password in the RAM 104. After the apparatus control unit 101a stores the user ID and the password in the RAM 104, the apparatus control unit 101a instructs the utilized server determining unit 115 to determine a server to be used, and sends the user ID and the password to the utilized server determining unit 115.

In the embodiment, the utilized server determining unit 115 determines a server to be used for the user authentication depending on whether the user inputs the user ID and the password or the biometric information. When the utilized server determining unit 115 receives the instruction to determine the server and the fingerprint information, the utilized server determining unit 115 determines that the biometric authentication server 500 is the server to be used, and sends the fingerprint information to the biometric authentication server 500 through the apparatus control unit 101a and the interface I/F 102. When the user inputs the user ID and the password and the biometric information reading unit 113 reads the fingerprint information concurrently, the utilized server determining unit 115 invalidates the authentication information input later.

On the other hand, when the utilized server determining unit 115 receives the user ID and the password from the user, the utilized server determining unit 115 determines that the authentication server 200 is the server to be used, and sends the user ID and the password to the authentication server 200 through the apparatus control unit 101a and the interface I/F 102.

As shown in FIG. 12, the biometric authentication server 500 includes a biometric server control unit 501 for controlling an entire operation of the biometric authentication server 500; a user biometric information database (DB) 502; and a user biometric information determining unit 503. Further, the biometric authentication server 500 includes an interface (I/F, not shown) for communicating with the image processing apparatus 100a connected thereto through the network 400.

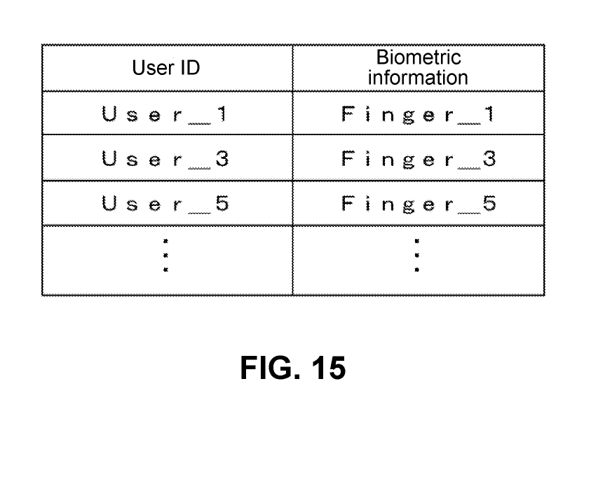

FIG. 15 is a schematic view showing an example of a configuration of the user biometric information database (DB) 502 according to the second embodiment of the present invention.

As shown in FIG. 15, the user biometric information database (DB) 502 stores user biometric information correlating the user IDs of a plurality of users with fingerprint information (Finger_1, Finger_2, Finger_3, etc) of the users. A server administrator registers and administers the user biometric information registered in the user biometric information database (DB) 502.

In the embodiment, when the biometric server control unit 501 receives the fingerprint information from the image processing apparatus 100a through the interface (I/F, not shown), the biometric server control unit 501 stores the fingerprint information in an RAM (not shown) disposed in the biometric authentication server 500. After the biometric server control unit 501 stores the fingerprint information, the biometric server control unit 501 instructs the user biometric information determining unit 503 to perform biometric authentication determination.

In the embodiment, when the user biometric information determining unit 503 receives the instruction of the biometric authentication determination, the user biometric information determining unit 503 searches the user biometric information database (DB) 502 according to the fingerprint information thus received. When the fingerprint information corresponding to the user is stored in the user biometric information database (DB) 502, the user biometric information determining unit 503 determines that the user matches to the biometric authentication information.

In general, the fingerprint information thus received rarely matches to the fingerprint information stored in the user biometric information database (DB) 502 with 100% certainty. Accordingly, when the user biometric information determining unit 503 performs the biometric authentication determination, and the fingerprint information thus received matches to the fingerprint information stored in the user biometric information database (DB) 502 with a threshold certainty (for example, 98%), the user biometric information determining unit 503 determines that the user matches to the biometric authentication information.

When the user biometric information determining unit 503 determines that the user matches to the biometric authentication information, the biometric server control unit 501 generates a user match signal, and sends the user match signal to the image processing apparatus 100a through the interface (I/F, not shown).

In the embodiment, it is arranged such that the biometric server control unit 501 sends the user match signal to the image processing apparatus 100a when the user biometric information determining unit 503 determines that the user matches to the biometric authentication information. Alternatively, it may be arranged such that the biometric server control unit 501 sends the user ID corresponding to the fingerprint information thus authenticated for identifying the authentication information to the image processing apparatus 100a.

When the fingerprint information corresponding to the user is not stored in the user biometric information database (DB) 502, the user biometric information determining unit 503 determines that the user does not match to the biometric authentication information. When the user biometric information determining unit 503 determines that the user does not match to the biometric authentication information, the biometric server control unit 501 generates a user mismatch signal, and sends the user mismatch signal to the image processing apparatus 100a through the interface (I/F, not shown).

In the embodiment, when the apparatus control unit 101a of the image processing apparatus 100a receives the user match signal through the interface I/F 102, the apparatus control unit 101a instructs the access authority determining unit 107a to determine access authority. On the other hand, when the apparatus control unit 101a of the image processing apparatus 100a receives the user mismatch signal through the interface I/F 102, the apparatus control unit 101a starts a corresponding program stored in the ROM 105a. Accordingly, failed login screen information is displayed on the touch panel display of the input display unit 103 to notify that the login is failed using a text and a prohibition marking (refer to FIG. 6). After the apparatus control unit 101a displays the failed login screen information on the touch panel display for a specific period of time set in advance, the apparatus control unit 101 displays the login screen information as the initial screen information shown in FIG. 14 on the touch panel display.

In the embodiment, the access authority determining unit 107a determines whether the access authority information corresponding to the user ID of the user thus authenticated or the fingerprint information is registered. When the access authority determining unit 107a determines that the access authority information is registered, the access authority determining unit 107a determines the access authority of the user according to the access authority identifier contained in the access authority information.

More specifically, when the access authority determining unit 107a receives the instruction to determine the access authority, the access authority determining unit 107a searches the access authority information database (DB) 1061a according to the user ID stored in the RAM 104 or the fingerprint information. When the access authority information corresponding to the user ID or the fingerprint information is stored in the access authority information database (DB) 1061a, the access authority determining unit 107a determines that the access authority identifier (1, 2, or 3) contained in the access authority information is the access authority of the user.

On the other hand, when the access authority information corresponding to the user ID or the fingerprint information is not stored in the access authority information database (DB) 1061a, the access authority determining unit 107a determines that the access authority information of the user is not registered. Accordingly, the access authority determining unit 107 determines that the access authority identifier “0” indicating the lowest access authority is the access authority of the user.

In the second embodiment, other components of the image processing apparatus 100a are similar to those of the image processing apparatus 100 in the first embodiment. Further, a configuration of the authentication server 200 or the user terminal 300 is similar to that of the authentication server 200 or the user terminal 300 in the first embodiment.

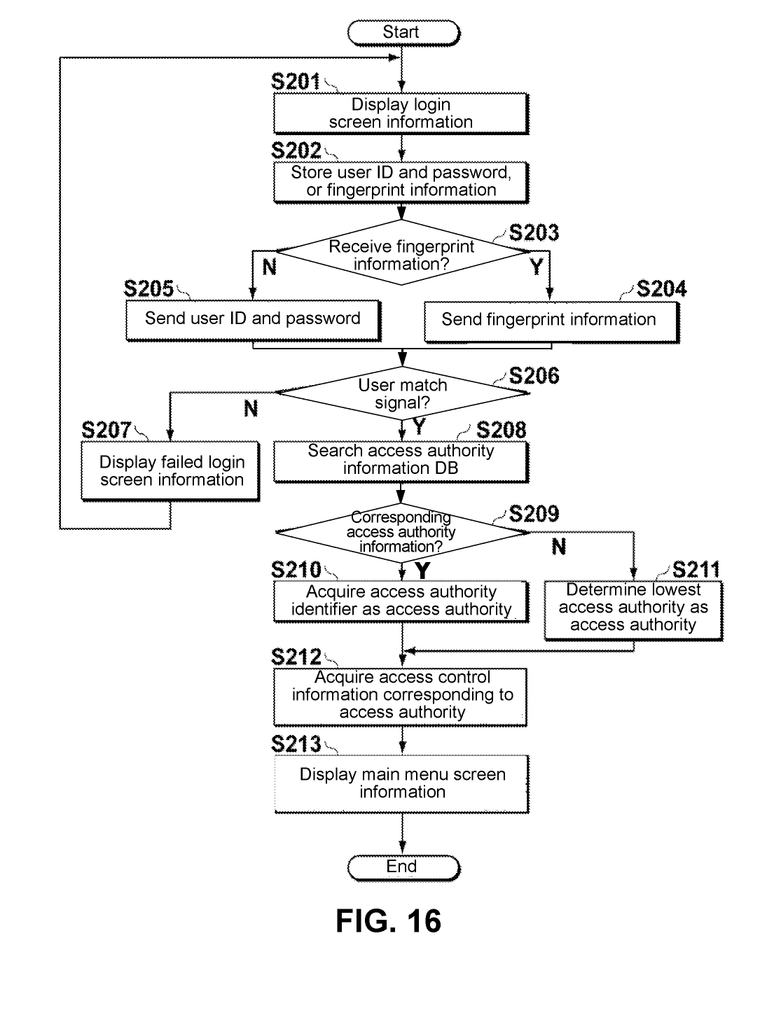

An operation of the image processing apparatus 100a will be explained next with reference to FIG. 16. FIG. 16 is a flow chart showing the operation of the image processing apparatus 100a according to the second embodiment of the present invention.

In the following description, as characteristic features of the image processing apparatus 100a, the explanation covers from an operation of displaying the login screen information on the touch panel display to an operation of generating the main menu screen information according to the access authority of the user of the image processing apparatus 100 and displaying the main menu screen information thus generated on the display.

In step S201, when the user operates the power switch (not shown) to turn on the image processing apparatus 100a, the apparatus control unit 101a starts the corresponding program stored in the ROM 105a. Accordingly, the login screen information (initial screen information) shown in FIG. 14 is displayed on the touch panel display of the input display unit 103, so that the user can input the user ID and the password, or the fingerprint thereof.

When the user refers to the login screen information displayed on the touch panel display, places an index finger on the glass plate of the biometric information reading unit 113, and pushes the glass plate, the sensor detects the index finger, and outputs the index finger detection signal.

When the biometric information reading unit 113 detects the index finger detection signal, the light source irradiates the index finger of the user placed on the glass plate, so that the fingertip shooting camera takes a picture of the fingertip, thereby generating the fingertip image. When the biometric information reading unit 113 generates the fingertip image, the apparatus control unit 101a stores the fingertip image in the RAM 104. After the apparatus control unit 101a stores the fingertip image in the RAM 104, the apparatus control unit 101a instructs the biometric information generating unit 114 to generate the fingerprint information.

In step S202, when the biometric information generating unit 114 receives the instruction to generate the fingerprint information, the biometric information generating unit 114 retrieves the fingerprint pattern from the fingertip image stored in the RAM 104, and codes the fingerprint pattern of the fingertip to generate the fingerprint information.

In the next step, when the biometric information generating unit 114 generates the fingerprint information, the apparatus control unit 101a stores the fingerprint information in the RAM 104. After the apparatus control unit 101a stores the fingerprint information in the RAM 104, the apparatus control unit 101a instructs the utilized server determining unit 115 to determine a server to be used, and sends the fingerprint information to the utilized server determining unit 115.

Further, when the user refers to the login screen information, and operates the input button of the input display unit 103 to input the user ID and the password, the apparatus control unit 101a stores the user ID and the password in the RAM 104. After the apparatus control unit 101a stores the user ID and the password in the RAM 104, the apparatus control unit 101a instructs the utilized server determining unit 115 to determine a server to be used, and sends the user ID and the password to the utilized server determining unit 115.

In step S203, when the utilized server determining unit 115 receives the instruction to determine the server and the fingerprint information, the utilized server determining unit 115 determines that the biometric authentication server 500 is the server to be used. In step S204, the utilized server determining unit 115 sends the fingerprint information to the biometric authentication server 500 through the apparatus control unit 101a and the interface I/F 102.

On the other hand, when the utilized server determining unit 115 receives the user ID and the password from the user, the utilized server determining unit 115 determines that the authentication server 200 is the server to be used. In step S205, the utilized server determining unit 115 sends the user ID and the password to the authentication server 200 through the apparatus control unit 101a and the interface I/F 102.

In the next step, when the biometric server control unit 501 receives the fingerprint information from the image processing apparatus 100a through the interface (I/F, not shown), the biometric server control unit 501 stores the fingerprint information in the RAM (not shown) disposed in the biometric authentication server 500. After the biometric server control unit 501 stores the fingerprint information, the biometric server control unit 501 instructs the user biometric information determining unit 503 to perform the biometric authentication determination.

In the next step, when the user biometric information determining unit 503 receives the instruction of the biometric authentication determination, the user biometric information determining unit 503 searches the user biometric information database (DB) 502 according to the fingerprint information thus received. When the fingerprint information corresponding to the user is stored in the user biometric information database (DB) 502, the user biometric information determining unit 503 determines that the user matches to the biometric authentication information. In the step, when the fingerprint information thus received matches to the fingerprint information stored in the user biometric information database (DB) 502 with the threshold certainty (for example, 98%), the user biometric information determining unit 503 determines that the user matches to the biometric authentication information.

In the next step, when the user biometric information determining unit 503 determines that the user matches to the biometric authentication information, the biometric server control unit 501 generates the user match signal, and sends the user match signal to the image processing apparatus 100a through the interface (I/F, not shown).

When the fingerprint information corresponding to the user is not stored in the user biometric information database (DB) 502, the user biometric information determining unit 503 determines that the user does not match to the biometric authentication information. When the user biometric information determining unit 503 determines that the user does not match to the biometric authentication information, the biometric server control unit 501 generates the user mismatch signal, and sends the user mismatch signal to the image processing apparatus 100a through the interface (I/F, not shown).

In step S206, when the apparatus control unit 101a of the image processing apparatus 100a receives the user match signal through the interface I/F 102, the apparatus control unit 101a instructs the access authority determining unit 107a to determine the access authority. On the other hand, when the apparatus control unit 101a of the image processing apparatus 100a receives the user mismatch signal through the interface I/F 102, the apparatus control unit 101a starts the corresponding program stored in the ROM 105a.

In step S207, the failed login screen information is displayed on the touch panel display of the input display unit 103 to notify that the login is failed using a text and a prohibition marking.

In the next step, after the apparatus control unit 101a displays the failed login screen information on the touch panel display for a specific period of time set in advance, the apparatus control unit 101 displays the login screen information as the initial screen information shown in FIG. 14 on the touch panel display.

In step S208, when the access authority determining unit 107a receives the instruction to determine the access authority, the access authority determining unit 107a searches the access authority information database (DB) 1061a according to the user ID stored in the RAM 104 or the fingerprint information.

In step S209, it is determined whether the access authority information corresponding to the user ID or the fingerprint information is stored in the access authority information database (DB) 1061a.

In step S210, when it is determined that the access authority information corresponding to the user ID or the fingerprint information is stored in the access authority information database (DB) 1061a, the access authority determining unit 107a determines that the access authority identifier (1, 2, or 3) contained in the access authority information is the access authority of the user.

On the other hand, when the access authority information corresponding to the user ID or the fingerprint information is not stored in the access authority information database (DB) 1061a, the access authority determining unit 107a determines that the access authority information of the user is not registered. In step S211, the access authority determining unit 107 determines that the access authority identifier “0” indicating the lowest access authority is the access authority of the user.

In step S212, similar to the image processing apparatus 100 in the first embodiment, when the access control information acquiring unit 108 receives the instruction to acquire the access control information, the access control information acquiring unit 108 searches the access control information database (DB) 1062 according to the access authority stored in the RAM 104 (for example, “0”). Accordingly, the access control information acquiring unit 108 acquires the access control information corresponding to the access authority.

In step S213, the image processing apparatus 100 generates the main menu screen information according to the access control information thus acquired, so that the main menu screen information thus generated is displayed on the touch panel display.

As described above, in the image processing apparatus 100a in the second embodiment, it is possible to perform a plurality of types of user authentication using a plurality of authentication serves storing different user authentication information. Accordingly, even if a user forgets a password corresponding to the user ID, the user can access to the image processing apparatus 100a using a fingerprint thereof, thereby improving convenience of the user.

Further, in the image processing system having the image processing apparatus 100a, it is possible to perform the biometric authentication using the biometric authentication server 500 for the user authentication of a user entering or moving out a room when the biometric authentication server 500 is installed on a door of the room. Accordingly, it is possible to utilize an existing server without installing a new biometric server of the image processing apparatus 100a.

In the first and second embodiments described above, when the user logs in the image processing apparatus 100 or the image processing apparatus 100a, the user operates the input button of the input display unit 103 to input the user ID and the password. Alternatively, the user may use an ID card to log in. In this case, the image processing apparatus 100 or the image processing apparatus 100a is provided with a card reading unit for reading identification information of the user from the ID card. The card reading unit may electrically or magnetically read the identification information of the user from the ID card.

In the second embodiment described above, the fingerprint is used as the biometric information. Alternatively, fingertip vein information or palm vein information may be used as the biometric information. In this case, the image processing apparatus 100a includes a reading unit for shooting a fingertip or a palm of the user to read a vein pattern thereof; and a generation unit for coding the vein pattern thus read to generate the fingertip vein information or the palm vein information.

In the first and second embodiments described above, the image processing apparatus 100 or the image processing apparatus 100a is the MFP (Multi Function Product) having the printer function and the scanning function. Alternatively, the present invention may be applicable to a printer, a copier, a facsimile, and a scanner having a single function. When the image processing apparatus has a single function, it may arranged such that a user with the access authority can access to image data in color and monochrome, and an unregistered user can access only to image data in monochrome.

The disclosure of Japanese Patent Application No. 2008-269622, filed on Oct. 20, 2008, is incorporated in the application by the reference.

While the invention has been explained with reference to the specific embodiments of the invention, the explanation is illustrative and the invention is limited only by the appended claims.

What is claimed is:

1. An image processing apparatus, comprising:
an input receiving unit for receiving an input of identification information to identify a user;
a storage unit for storing the identification information and usage authority of the user with respect to a function of the image processing apparatus;
a control information storage unit for storing unregistered user control information for allowing an unregistered user with usage authority not registered in the storage unit to use a minimum function of the image processing apparatus;
a determining unit for searching the storage unit according to the identification information and determining whether the identification information is registered; and
a control unit for controlling to allow the unregistered user to use the minimum function according to the unregistered user control information when the determining unit determines that the identification information is not registered in the storage unit.

2. The image processing apparatus according to claim 1, wherein said control unit is arranged to control to allow or not to allow the user to use the function of the image processing apparatus according to the usage authority corresponding to the identification information when the determining unit determines that the identification information is registered in the storage unit.

3. The image processing apparatus according to claim 2, wherein said control unit is arranged to control to allow the unregistered user to use the minimum function including one of a printing function and a scanning function.

4. The image processing apparatus according to claim 1, wherein said input receiving unit is arranged to receive the input of the identification information of one type or a plurality of types.

5. The image processing apparatus according to claim 1, wherein said input receiving unit is arranged to receive the input of the identification information including biometric information.

6. The image processing apparatus according to claim 1, wherein said input receiving unit includes an operation panel so that the identification information is input through the operation panel.

7. The image processing apparatus according to claim 1, wherein said input receiving unit is arranged to receive the input of the identification information electrically or magnetically stored in a medium so that the input receiving unit has a function of acquiring the identification information stored in the medium.

8. The image processing apparatus according to claim 1, further comprising an external device determining unit for determining an external device to which the identification information is to be transmitted according to a type of the identification information, and a transmission and reception unit for transmitting the identification information to the external device and receiving an authentication determining result according to the identification information from the external device.
